(19) United States
(12) Patent Application Publication
(10) Pub. No.: US 2024/0253514 A1
(43) Pub. Date: Aug. 1, 2024

(54) Electronic Vehicle Charging Configuration to Decrease Vehicle Charging Times

(71) Applicant: Steven Bowman, Ames, IA (US)

(72) Inventor: Steven Bowman, Ames, IA (US)

(21) Appl. No.: 18/104,774

(22) Filed: Feb. 1, 2023

(51) Int. Cl. B60L 53/67; B60L 53/53

(52) U.S. Cl. CPC B60L 53/67; B60L 53/53

(57) ABSTRACT

This new application is for using multiple Electric Vehicle Charging stations together with multiple vehicle charger inputs to simultaneously charge an electric vehicle thereby decreasing vehicle charging times.

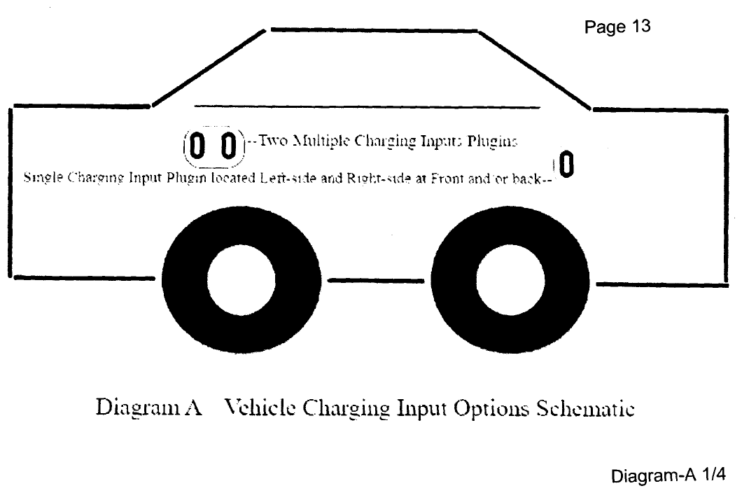

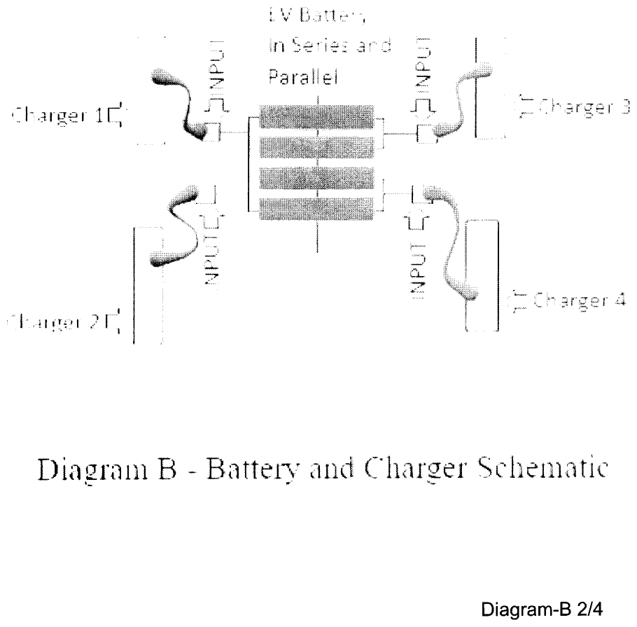

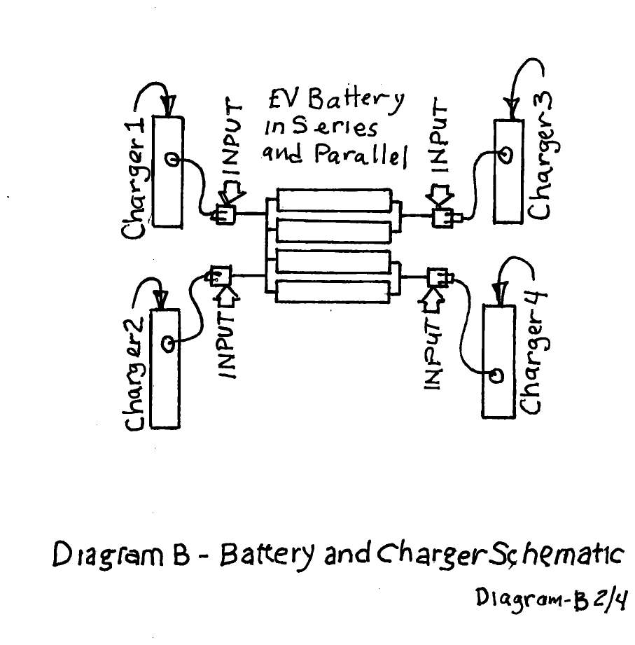

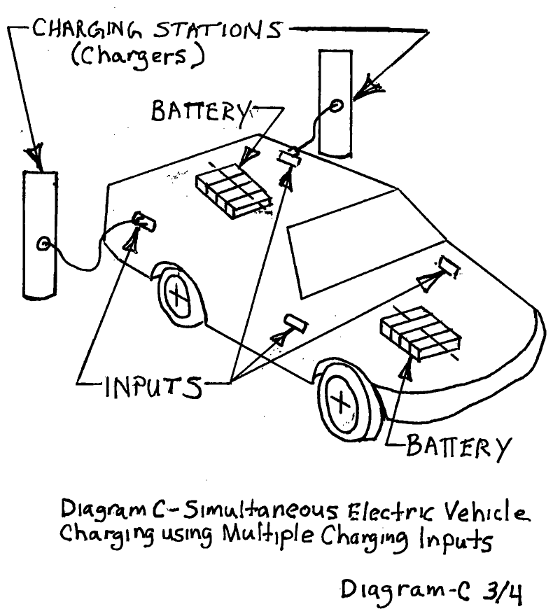

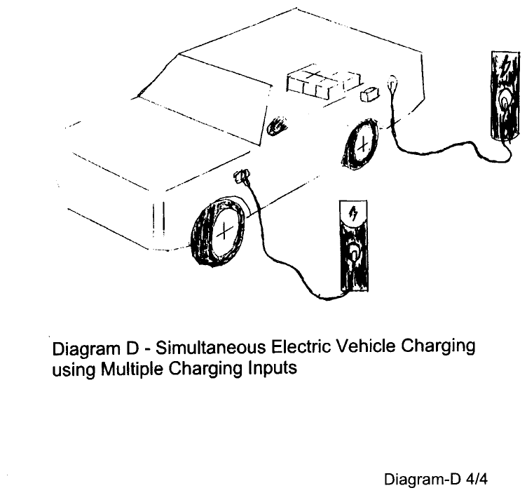

EV Battery charging diagram using multiple charging stations and multiple charger inputs to charge an electric vehicle battery. Batteries may be in series or parallel using alternating current/AC or direct current/DC chargers.

### BACKGROUND OF THE INVENTION

This Utility patent applies to the field of electric vehicles battery charging.

The demand and proliferation of electric vehicles is constrained by the lack of available vehicle charging stations and the excessive amount of time needed to charge electric vehicles compared to the time needed to fill a gasoline or other liquid powered vehicle that does not propelled using electric powered drivetrains.

### BRIEF SUMMARY OF THE INVENTION

The idea behind this Utility patent is to modify automobiles and reconfigure electric vehicle charging stations to allow vehicles to be charged using multiple charging inputs concurrently.

Simultaneous charging using multiple charging station plug-ins will decrease the amount of time needed to charge an electric vehicle's batteries.

### BRIEF DESCRIPTION OF THE SEVERAL VIEWS OF THE DRAWINGS

EV Battery charging diagram using multiple charging stations and multiple charger inputs to charge an electric vehicle battery. Batteries may be in series or parallel using alternating current/AC or direct current/DC chargers.

Diagram A: Vehicle Charging Input Options Schematic

Diagram B: Battery (series and-or parallel) and Charging Schematic

Diagram C: Simultaneous Electric Vehicle Charging using Multiple Charging Inputs

Diagram D: Simultaneous Charging using Multiple Charging Inputs.

### DETAILED DESCRIPTION OF THE INVENTION

Electric vehicles are charged using various classes of charger plug-ins or connectors: level 1, level 2 or level 3, level 3 is known to be a fast charger, requiring the least amount of time for charging. Additionally, some vehicle manufacturers plug-in receivers vary in design or carry proprietary plug-ins. Some vehicle makers have multiple electric vehicle receiver inputs to accommodate different types of charging station inputs however, they are designed for charging using only one charging input, not simultaneous input charging.

Per the Vehicle Charging Input and Charging Option Schematics, vehicles will utilize multiple charging station inputs concurrently. Vehicle manufactures will need to modify vehicle panels and charging station receiver inputs to allow vehicles to be charged using multiple charging stations. Vehicle panels will need to be redesigned to accommodate the additional charging station plug-ins.

Charging connectors/inputs located on vehicles should be positioned (including retrofits) on vehicles in accordance with manufacture's recommendations and directions using vehicle converters and chargers.

Additional Alternating Current/AC on-board chargers/converters and Direct Charge/DC charging modulators will be required. Batteries may be in series and/or parallel.

Electric Vehicle charging stations may need to be repositioned to accommodate the multiple plug-in locations located on vehicles.

1. Decrease the amount of time needed to charge Electric Vehicle Batteries.
